(19) United States
(12) Patent Application Publication
(10) Pub. No.: US 2026/0145080 A1
(43) Pub. Date: May 28, 2026

(54) METHOD FOR DISPLAYING AN INTERFACE AND APPARATUS, ELECTRONIC DEVICE, COMPUTER-READABLE STORAGE MEDIUM, AND COMPUTER PROGRAM PRODUCT

(71) Applicant: TENCENT TECHNOLOGY (SHENZHEN) COMPANY LIMITED, Shenzhen (CN)

(72) Inventors: Zhenyu LIU, Shenzhen (CN); Yingjie MEI, Shenzhen (CN); Wen QIAO, Shenzhen (CN); Qiang LIN, Shenzhen (CN); Xiaozhen DAI, Shenzhen (CN); Hongjiang WANG, Shenzhen (CN)

(21) Appl. No.: 19/455,232

(22) Filed: Jan. 21, 2026

Related U.S. Application Data
(63) Continuation of application No. PCT/CN2024/123889, filed on Oct. 10, 2024.

(30) Foreign Application Priority Data
Dec. 21, 2023 (CN) 202311778927.3

(51) Int. Cl. A63F 13/69; A63F 13/52; G06F 3/04817

(52) U.S. Cl. CPC A63F 13/69; A63F 13/52; G06F 3/04817; A63F 2300/308

(57) ABSTRACT

This application discloses an method for displaying an interface and apparatus, an electronic device, a computer-readable storage medium and a computer program product, and relates to the field of computer technologies. The method includes: displaying an event reward interface, and displaying, on the event reward interface, a reward identifier of at least one stage in an event, the event including at least two stages, and each stage including at least two sub-stages; and displaying a reward identifier of a sub-stage within a first target stage in response to a reward identifier of the first target stage being selected, the first target stage being any one of the at least two stages included in the event, and the reward identifier of the sub-stage being configured for representing a reward allowed to be collected after the sub-stage is completed.

### RELATED APPLICATIONS

This application is proposed is a continuation of PCT Application No. PCT/CN2024/123889 filed on Oct. 10, 2024, which claims priority to Chinese Patent Application No. 2023117789273, filed on Dec. 21, 2023, which are both incorporated herein by reference in their entirety.

### FIELD OF THE TECHNOLOGY

Embodiments of this application relate to the field of computer technologies, and in particular, to an method for displaying an interface and apparatus, an electronic device, a computer-readable storage medium, and a computer program product.

### BACKGROUND OF THE DISCLOSURE

With the development of computer technologies and a substantial increase in user scale, to improve user activeness, events are held in a plurality of applications and rewards are provided to attract users to participate in the events.

A plurality of rewards is usually provided for the events, and reward identifiers corresponding to the plurality of rewards are displayed on an event reward interface in a tiled manner based on an arrangement sequence of the plurality of rewards. However, in this tiled display manner, an excessive quantity of reward identifiers are displayed, resulting in lacking emphasis. This results in user spending more time to learn about a core reward for an event, which causes low efficiency of reward viewing, and requires more display regions to be occupied to display rewards, and affects use of other functions in an application.

### SUMMARY

An embodiment of this application provides an method for displaying an interface and apparatus, an electronic device, a computer-readable storage medium, and a computer program product, which can improve efficiency of viewing rewards and reduce an impact on use of another function in an application. The technical solutions are as follows.

An embodiment of this application provides an method for displaying an interface, performed by an electronic device and including displaying an event reward interface, and displaying, a reward identifier of at least one stage in an event on the event reward interface, the event comprising at least two stages, and each stage comprising at least two sub-stages; and displaying a reward identifier of a sub-stage within a first target stage in response to a reward identifier of the first target stage being selected, the first target stage being a stage in the at least two stages in the event, and the reward identifier of the sub-stage representing a reward to be collected after the sub-stage is completed.

An embodiment of this application provides an electronic device, the electronic device including a processor and a memory, the memory having at least one computer program or computer-executable instructions stored therein, and the at least one computer program or the computer-executable instructions being loaded and executed by the processor to implement operations performed in the method for displaying an interface according to the foregoing aspect.

An embodiment of this application provides a non-transitory computer-readable storage medium, the computer-readable storage medium having at least one computer program or computer-executable instructions stored thereon, and the at least one computer program or the computer-executable instructions being loaded and executed by a processor to implement operations performed in the method for displaying an interface according to the foregoing aspect.

In one embodiment, a reward identifier of at least one stage in the event is displayed based on the event reward interface, and when the reward identifier of the first target stage is selected, the reward identifier of the sub-stage within the first target stage is then displayed, rather than displaying all the reward identifiers at once. Accordingly, a quantity of reward identifiers displayed once can be effectively reduced, so that a stage-level relationship between different reward identifiers may be intuitively presented, and it is easier for a user to browse reward identifiers of the event. Furthermore, efficiency of reward viewing is improved, display region required for reward display can be minimized, and an impact on use of other functions in an application is reduced.

### BRIEF DESCRIPTION OF THE DRAWINGS

To describe technical solutions of embodiments of this application more clearly, the following briefly describes the accompanying drawings required for describing embodiments. Apparently, the accompanying drawings in the following descriptions show only some embodiments of this application, and a person of ordinary skill in the art may still derive other drawings from these accompanying drawings without creative efforts.

FIG. 1 is a schematic diagram of an implementation environment according to an embodiment of this application.

FIG. 2 is a flowchart of an method for displaying an interface according to an embodiment of this application.

FIG. 3 is a schematic diagram of an event reward interface according to an embodiment of this application.

FIG. 4 is a schematic diagram of reward identifiers of a sub-stage according to an embodiment of this application.

FIG. 5 is a schematic diagram of reward identifiers of another sub-stage according to an embodiment of this application.

FIG. 6 is flowchart of another method for displaying an interface according to an embodiment of this application.

FIG. 7 is a schematic diagram of another event reward interface according to an embodiment of this application.

FIG. 8 is a schematic diagram of another event reward interface according to an embodiment of this application.

FIG. 9 is a schematic diagram of another event reward interface according to an embodiment of this application.

FIG. 10 is flowchart of another method for displaying an interface according to an embodiment of this application.

FIG. 11 is a schematic diagram of an additional reward identifier according to an embodiment of this application.

FIG. 12 is a schematic diagram of an operation process according to an embodiment of this application.

FIG. 13 is a schematic diagram of a pre-event interface according to an embodiment of this application.

FIG. 14 is a schematic diagram of a structure of an interface display apparatus according to an embodiment of this application.

FIG. 15 is a schematic diagram of a structure of another interface display apparatus according to an embodiment of this application.

FIG. 16 is a schematic diagram of a structure of an electronic device according to an embodiment of this application.

### DESCRIPTION OF EMBODIMENTS

To make objectives, technical solutions, and advantages of embodiments of this application clearer, the following further describes in detail implementations of this application with reference to the accompanying drawings.

Terms “first”, “second”, and the like used in this application may be configured for describing various concepts in this specification. However, these concepts are not limited by the terms unless otherwise specified. The terms are merely configured for distinguishing one concept from another concept. For example, without departing from the scope of this application, a first stage may be referred to as a second stage, and similarly, the second stage may be referred to as the first stage.

“At least two” means two or more. For example, at least two stages may be stages whose quantity is any integer greater than or equal to two, such as two stages or three stages. “Each” means each of at least two. For example, each stage means each of the at least two stages. If the at least two stages are three stages, each stage means each of the three stages.

Information (including but not limited to user equipment information, personal information of a user, and the like), data (including but not limited to data configured for analysis, stored data, displayed data, and the like), and signals (including but not limited to signals transmitted between a user terminal and another device, and the like) involved in this application are used under authorization by the user or full authorization by all parties, and collection, use, and processing of related data need to conform to related laws, regulations, and standards of related countries and regions.

With research and progress of artificial intelligence (AI) technologies, the artificial intelligence technologies are studied and applied in a plurality of fields, such as a common smart home, a smart wearable device, a virtual assistant, a smart speaker, smart marketing, self-driving, autonomous driving, an unmanned aerial vehicle, a robot, an AI-generated content (AIGC), a dialogue interaction, smart medical care, smart customer service, a game AI, and the like. It is believed that with development of technologies, the artificial intelligence technologies are applied in more fields and play increasingly important value.

Solutions provided in embodiments of this application relate to technologies such as computer vision of artificial intelligence, which are described in detail in the following embodiments.

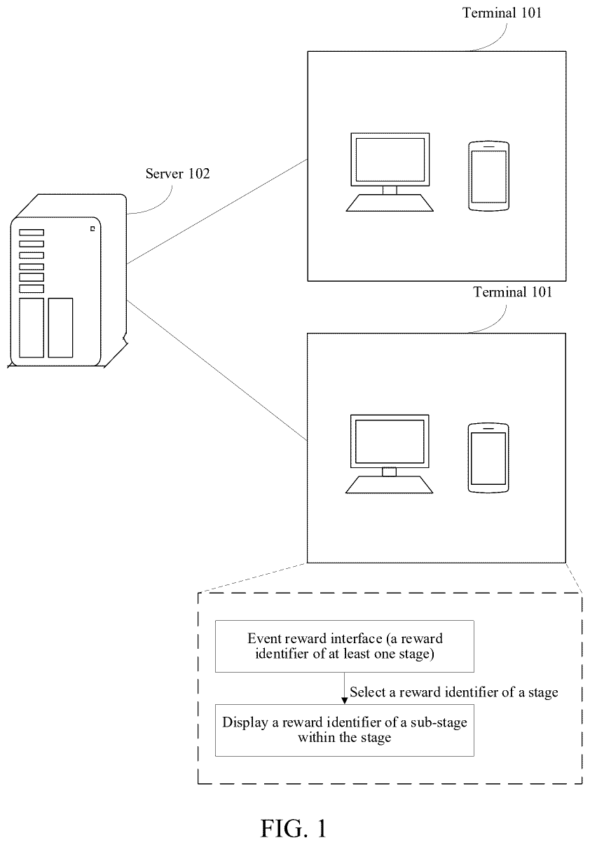

FIG. 1 is a schematic diagram of an implementation environment according to an embodiment of this application. Refer to FIG. 1. The implementation environment includes a plurality of terminals 101 (where two terminals are used as an example in FIG. 1, and a terminal is an implementation of an electronic device) and a server 102. The plurality of terminals 101 and the server 102 are connected to each other through a wired or wireless network.

In embodiments of this application, the terminal may be a smartphone, a tablet computer, a notebook computer, a desktop computer, a smart speaker, a smartwatch, a smart game console, a smart television, or the like, but is not limited thereto. Embodiments of this application may be applied to various scenarios, including but not limited to a cloud technology, artificial intelligence, smart transportation, driver assistance, and the like.

The server is an independent physical server, or a server cluster or a distributed system including a plurality of physical servers, or a cloud server that provides basic cloud computing services such as a cloud service, a cloud database, cloud computing, a cloud function, cloud storage, a network service, cloud communication, a middleware service, a domain name service, a security service, a content delivery network (CDN), a big data and artificial intelligence platform.

In one embodiment, the server 102 holds an event, and the plurality of terminals 101 may participate in the event held by the server 102, to collect a reward for the event. Considering that there are a large quantity of rewards, for convenience of displaying reward identifiers, the event is divided into a plurality of stages, each stage is divided into at least two sub-stages, and a reward is provided for each sub-stage. The terminal 101 can collect a reward for a sub-stage by completing a task in the sub-stage. A reward identifier of at least one stage is displayed on an event reward interface in the terminal 101, and if a reward identifier of a stage is selected, reward identifiers of sub-stages within the stage are displayed.

A target application served by the server 102 is installed in each terminal 101, and the plurality of terminals 101 can interact through the target application. The target application has a plurality of functions, such as a game function, a shopping function, and a chat function. In some embodiments, the server 102 is a background server of the target application or a cloud server that provides services such as cloud computing and cloud storage to the target application.

In e one embodiment, a computer program or computer-executable instructions in embodiments of this application may be deployed on an electronic device for execution, or may be executed on a plurality of electronic devices at one location, or may be executed on a plurality of electronic devices distributed at a plurality of locations and interconnected through a communication network. The plurality of electronic devices distributed at the plurality of locations and interconnected through the communication network can form a blockchain system.

A method provided in an embodiment of this application may be applied to a plurality of scenarios. An example in which an electronic device is implemented as a terminal is used to describe a scenario to which the method provided in one embodiment may be applied.

For example, in a scenario in which an event held by a server is a game season:

The server holds the game season. The game season includes a plurality of game competitions. The terminal may participate in a game competition, view a game competition, or perform another task related to a game competition, to increase a level of a logged-in account. The server further divides the game season into a plurality of level intervals (that is, a plurality of stages) according to different levels, sets at least two levels (that is, at least two sub-stages) in each level interval, and provides a reward for each level. A user opens a reward interface (namely, an event reward interface) in the terminal. Core reward icons (namely, core reward identifiers) of the level intervals are displayed on the reward interface. If a core reward icon of a level interval is selected, reward icons of levels (reward identifiers of sub-stages) within the level interval are further displayed. By browsing the reward interface, the user can quickly learn about a core reward for each level interval and a reward for each level in the season, and can also quickly find, based on a current level of the user, a reward that the user can collect.

For another example, in a scenario in which an event held by a server is a live streaming event:

The server holds a live streaming event, invites a live streaming account to perform live streaming, and further sets, according to different live streaming durations, a plurality of duration intervals (that is, a plurality of stages) for the live streaming event, sets at least two durations (that is, at least two sub-stages) in each duration interval, and provides a reward for each duration. A user opens a reward interface in the terminal. Core reward icons (namely, core reward identifiers) of the duration intervals are displayed on the reward interface. When a core reward icon of a duration interval is selected, reward icons of duration intervals (reward identifiers of sub-stages) within the duration interval are further displayed. By browsing the reward interface, the user can quickly learn about a core reward for each duration interval and a reward for each duration in the event, and can also quickly find, based on a current live streaming duration of the user, a reward that the user can collect.

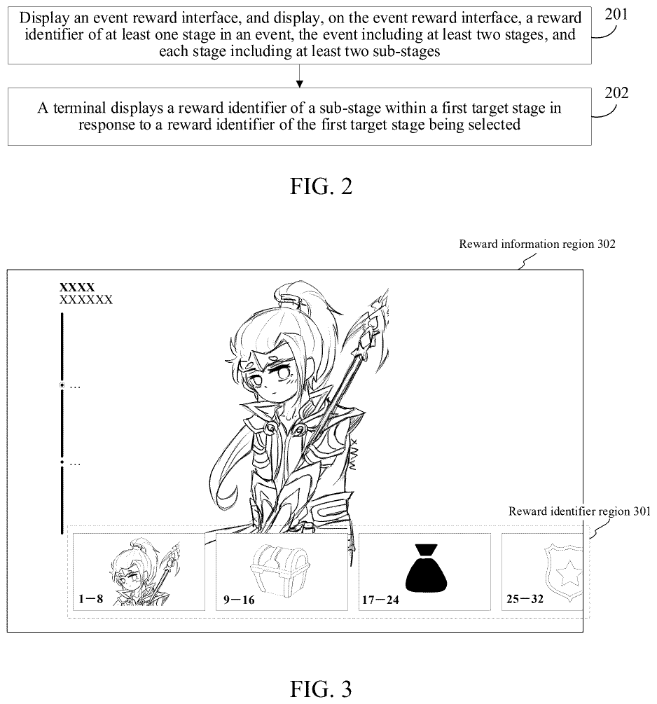

FIG. 2 is a flowchart of an method for displaying an interface according to an embodiment of this application. One embodiment is performed by an electronic device. The electronic device herein may be implemented as various types of terminals. The following uses a terminal as an example to describe the method for displaying an interface. Refer to FIG. 2. The method includes the following operations.

201: Display an event reward interface, and display, on the event reward interface, a reward identifier of at least one stage in an event, the event including at least two stages, and each stage including at least two sub-stages.

One embodiment is applied to a scenario of holding an event. The event includes at least two stages, each stage includes at least two sub-stages, and quantities of sub-stages within different stages may be the same or different. The event may include a plurality of types such as a game season, live streaming, voting, and question answering. The stage herein is a part obtained through dividing the event according to a specific sequence (for example, a chapter sequence of a game plot) and a task objective (for example, understanding a rule of an event or completing a combat), and the sub-stage is a part obtained through dividing the stage according to a specific sequence and a task objective.

In one embodiment, the terminal participates in an event, and performs a task specified in the event, so that a level of a terminal account can be upgraded. In this case, a stage of the event is a level interval, and a sub-stage is a level. Different levels reached by the terminal account are equivalent to completing different sub-stages.

In another embodiment, the terminal participates in an event, and performs a task specified by the event, so that a point for the terminal account can be accumulated. In this case, a stage of the event is a point interval, and a sub-stage is a point. Different points accumulated by the terminal account are equivalent to completing different sub-stages.

The event reward interface is configured for displaying a reward identifier of the event. The reward identifier is configured for describing a reward that can be collected by participating in the event. The reward is provided as an incentive to encourage a user to participate in the event. In other words, the reward is recognition for a resource (for example, time or a virtual gold coin) invested by the user in the event. User interest and user experience in the event can be improved by using the reward. The reward may include a plurality of types such as a virtual character in the game, a skin of the virtual character, a virtual item, a display effect used in the game, a virtual coin, an experience point, and a game point, the reward identifier may include information such as a reward name, a reward picture, and a reward introduction, and the reward identifier may be in a plurality of styles such as a card and an icon. The reward identifier includes partial information about the reward. The user may learn about the partial information about the reward by viewing the reward identifier. The reward identifier described herein may be a reward identifier of a stage in the event, or may be a reward identifier of a sub-stage within the stage.

When the terminal opens the event reward interface, the reward identifier may be displayed by stage on the event reward interface. Therefore, a reward identifier of at least one stage in the event is displayed, rather than displaying reward identifiers of all sub-stages at once. Accordingly, a quantity of reward identifiers displayed on the event reward interface once can be effectively reduced, so that a user can easily browse the reward identifiers, to improve clarity and organization of the event reward interface.

A reward identifier of a stage may be a reward identifier of one sub-stage within the stage, or include reward identifiers of all sub-stages within the stage, or may be a core reward identifier of the stage. The core reward identifier is a reward identifier of a reward that is in rewards for the sub-stages within the stage and that meets a core condition. This is not limited in embodiments of this application.

In addition, the event includes at least two stages, and the terminal may display reward identifiers of all stages. Alternatively, when display space on the event reward interface is insufficient to display reward identifiers of all stages, the terminal may display a reward identifier of a part of the stages. For example, the terminal displays reward identifiers of a fixed quantity of stages, and displays an expansion control. When the user triggers the expansion control, the terminal then displays a reward identifier of another stage. Alternatively, the terminal displays a reward identifier of a part of stages, and may display a reward identifier of another stage by performing a sliding operation or a page turning operation.

In addition, the terminal may display the event reward interface in the following several manners. For example, the terminal may display an event control on a main interface of an application, and in response to a trigger operation performed by a user on the event control, display the event reward interface on the main interface of the application, or switch the main interface of the application to the event reward interface. For another example, the event reward interface is set as the main interface of the application, to directly enter the event reward interface when the terminal starts the application. For another example, when starting the application, the terminal automatically displays the event reward interface in a form of a pop-up window on an upper layer of the main interface of the application. A display manner of the event reward interface is not limited in embodiments of this application.

202: The terminal displays a reward identifier of a sub-stage within a first target stage in response to a reward identifier of the first target stage being selected.

The first target stage is any one of the at least two stages included in the event. In one embodiment, an example in which the first target stage is selected is used for description, and a processing process when another stage is selected is similar. Details are not described in one embodiment.

When the reward identifier of the first target stage is selected, the terminal then continues to display the reward identifier of the sub-stage within the first target stage. The reward identifier of the sub-stage is configured for representing a reward allowed to be collected after the sub-stage is completed. Accordingly, the user can view a reward that can be collected after the sub-stage within the first target stage is completed.

In one embodiment, the first target stage may be determined through a selection operation on a reward identifier. The selection operation on the reward identifier may include an operation of tapping/clicking the reward identifier, an operation of touching and holding the reward identifier, an operation of sliding the reward identifier, or the like, or may further include another operation performed by the terminal. For example, when the event reward interface is displayed for the first time, the 1^{st} stage in the event is automatically selected as the first target stage, in other words, a reward identifier of the 1^{st} stage is automatically marked as being selected. After the reward identifier of the first target stage is selected, the terminal displays, on the event reward interface, a reward identifier of a sub-stage within the first target stage.

In some embodiments, the first target stage may be the 1^{st} stage of the event, may be the 1^{st} uncompleted stage of an account, or may be the last stage of the event. The following separately describes display of reward identifiers of the three cases.

In some embodiments, when the event reward interface is displayed for the first time, the first target stage includes the 1^{st} stage in the at least two stages included in the event, so that operation 202 of displaying the reward identifier of the sub-stage within the first target stage in response to the reward identifier of the first target stage being selected may include: displaying a reward identifier of a sub-stage within the 1^{st} stage in response to the reward identifier of the 1^{st} stage being selected.

When the event reward interface is displayed for the first time, the terminal automatically selects the reward identifier of the 1^{st} stage in the event, so that after the reward identifier of the 1^{st} stage is selected, the reward identifier of the sub-stage within the 1^{st} stage is displayed. Therefore, when opening the event reward interface for the first time, a user may watch a picture in which the reward identifier of the 1^{st} stage is automatically expanded, to learn that a reward identifier of a sub-stage within a stage can be displayed by selecting a reward identifier of the stage.

In some embodiments, the first target stage includes the 1^{st} uncompleted stage, so that operation 202 of displaying the reward identifier of the sub-stage within the first target stage in response to the reward identifier of the first target stage being selected may include: displaying a reward identifier of a sub-stage in the 1^{st} uncompleted stage of an account in response to a reward identifier of the 1^{st} uncompleted stage of the account being selected.

After the account logged in on the terminal participates in the event, the account may complete at least one sub-stage of the event. In this case, when the terminal displays the event reward interface, the terminal automatically selects a reward identifier of the 1^{st} stage in all stages that have not been completed by the account, that is, the reward identifier of the 1^{st} uncompleted stage. Then, the terminal displays the reward identifier of the sub-stage within the 1^{st} uncompleted stage of the account in response to the reward identifier of the 1^{st} uncompleted stage of the account being selected. The 1^{st} uncompleted stage of the account is a stage to which the 1^{st} uncompleted sub-stage of the account belongs. For example, a current level of the account is 5, a level of the 1^{st} uncompleted sub-stage is 6, and the 1^{st} uncompleted stage is a level interval of “1-8”. The 1^{st} uncompleted stage of the account includes both a completed sub-stage of the account and an uncompleted sub-stage of the account, so that a reward identifier of the completed sub-stage and a reward identifier of the uncompleted sub-stage of the account are displayed in an identifiable manner, for example, displayed in different colors or displayed in different styles. In addition, when display space on the event reward interface is insufficient to display reward identifiers of all sub-stages, it also needs to be ensured that the reward identifier of the 1^{st} uncompleted stage of the account needs to be displayed on the event reward interface, so that a user learns about a reward that can be collected in a next operation.

The terminal may display, on a side of the reward identifier of the first target stage, the reward identifier of the sub-stage within the first target stage. For example, the reward identifier of the sub-stage is displayed on the top, bottom, left, or right of the reward identifier of the first target stage.

In one embodiment, the reward identifier of the first target stage is first displayed, and the reward identifier of the sub-stage is hidden. In this case, the reward identifier of the first target stage is in a folded state. Then, when the reward identifier of the first target stage is selected, the reward identifier of the sub-stage within the first target stage is then displayed. In this case, the reward identifier of the first target stage is in an expanded state. An effect of exposing the reward identifier of the sub-stage that is hidden beneath the reward identifier of the first target stage is simulated, so that the reward identifier of the sub-stage is displayed in a “drawer-style” manner.

The first target stage includes at least two sub-stages. In response to the reward identifier of the first target stage being selected, the terminal may display reward identifiers of all sub-stages within the first target stage, or may display a reward identifier of a part of the sub-stages within the first target stage considering that display space on the event reward interface is insufficient to display the reward identifiers of all the sub-stage within the first target stage. For example, the terminal displays reward identifiers of a fixed quantity of sub-stages, and displays an expansion control. When a user triggers the expansion control, the terminal then displays a reward identifier of another sub-stage within the first target stage. Alternatively, the terminal displays a reward identifier of a part of sub-stages within the first target stage, and may display a reward identifier of another sub-stage by performing a sliding operation or a page turning operation.

In some embodiments, after operation 202 is performed, the method further includes: canceling display of the reward identifier of the sub-stage within the first target stage in response to the reward identifier of the first target stage being selected again. Accordingly, the reward identifier of the first target stage can be restored from the expanded state to the folded state again, so that more display space is left to display a reward identifier of another stage.

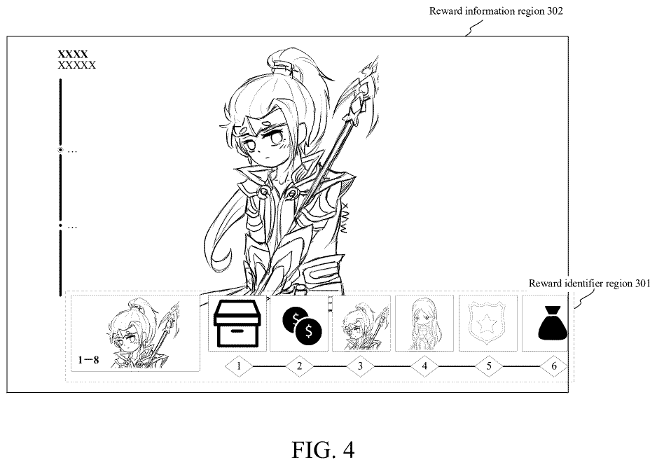

For example, as shown in FIG. 3, an event is divided into 11 stages according to different account levels, every eight levels form a level interval (for example, level intervals “1-8”, “9-16”, “17-24”, and “25-32” in FIG. 3), and one level interval is one stage. A terminal displays, on an event reward interface, reward icons of the first four level intervals. As shown in FIG. 4, when a reward icon of the 1^{st} level interval is selected, reward icons of levels in the 1^{st} level interval are displayed, so that rewards that can be collected when an account reaches each level within the level interval “1-8”. When the reward icon of the 1^{st} level interval is selected again, the reward icons of the levels within the 1^{st} level interval are folded, and the event reward interface is restored to a style shown in FIG. 3.

In some embodiments, when a reward identifier of a stage or a reward identifier of a sub-stage is selected, a reward identifier of another stage or a reward identifier of another sub-stage may further be selected. This is not limited in embodiments of this application.

In one embodiment, for ease of distinguishing different levels of stages, a next level of a stage is referred to as a sub-stage, but the event is not limited to include only a two-level stage. For example, the event includes a three-level stage, a second-level stage is a sub-stage of a first-level stage, and a third-level stage is a sub-stage of the second-level stage. For example, the three-level stage set in the event is shown in the following Table 1. Three major-level intervals are set in the event, each major-level interval includes two minor-level intervals, and 5 levels are set in each minor-level interval.

TABLE 1

| | | | |
|---|---|---|---|
| Major-level | [0, 100] | [101, 200] | [201, 300] |
| interval | | | |
| Minor-level | [0, 50] | [101, 150] | [201, 250] |
| interval | [51, 100] | [151, 200] | [251, 300] |
| Levels | 10, 20, 30, 40, | 110, 120, 130, 140, | 210, 220, 230, 240, |
| | 50, 60, 70, | 150, 160, 170, 180, | 250, 260, 270, 280, |
| | 80, 90, 100 | 190, 200 | 290, 300 |

In this case, the terminal displays, on the event reward interface, a reward identifier of the first-level stage. When the reward identifier of the first-level stage is selected, a reward identifier of a next-level stage can be displayed. A manner of displaying the reward identifiers stage by stage is used to effectively reduce a quantity of displayed reward identifiers, and a stage-level relationship between different reward identifiers can be presented in a more clearly and organized manner, so that reward identifiers are displayed in a more clearly and organized manner.

If stages and sub-stages are not distinguished from each other, the reward identifiers of the stages in the event are directly displayed in a tiled manner. Consequently, an excessive quantity of reward identifiers are displayed, resulting in lacking emphasis. It is difficult for a user to browse, and the user cannot quickly learn about a core reward for this event, resulting in a poor display effect.

However, in a solution of one embodiment, a reward identifier of at least one stage in the event is first displayed on the event reward interface, and when the reward identifier of the first target stage is selected, the reward identifier of the sub-stage within the first target stage is then displayed, rather than displaying all the reward identifiers at once. In this case, a quantity of reward identifiers displayed once can be effectively reduced, so that it is easier for a user to browse a reward identifier, to improve clarity and organization of the event reward interface. In addition, a stage-level relationship between different reward identifiers can be presented in a more clearly and organized manner, to improve a display effect of the event reward interface.

In addition, when the reward identifier of the first target stage is selected again, display of the reward identifier of the sub-stage within the first target stage is cancelled, so that display space on the event reward interface can be effectively saved, and it is convenient for the user to browse a reward identifier of another stage.

Based on the embodiment shown in FIG. 2, at least one of the stages displayed on the event reward interface may include the first target stage and a second target stage, and the second target stage is a stage following the first target stage in the at least two stages included in the event. In this case, for a display position of a reward identifier of a sub-stage, one embodiment provides the following embodiments.

In a first embodiment, operation 202 includes: displaying, between the reward identifier of the first target stage and a reward identifier of the second target stage, the reward identifier of the sub-stage within the first target stage in response to the reward identifier of the first target stage being selected.

A plurality of stages in the event are arranged in sequence, and reward identifiers of the plurality of stages are also sequentially arranged in a sequence of the plurality of stages. When the reward identifier of the first target stage is selected, the reward identifier of the sub-stage within the first target stage is displayed between the reward identifier of the first target stage and the reward identifier of the second target stage. Accordingly, the reward identifier of the stage and the reward identifier of the sub-stage can be arranged in the same row, to ensure clarity and organization of the event reward interface. This neither disrupts a sequence of the reward identifiers of the stages, nor prevents the reward identifier of the sub-stage within the first target stage from being displayed.

In some embodiments, for ease of distinguishing a reward identifier of a stage and a reward identifier of a sub-stage, a style of the reward identifier of the stage may be different from a style of the reward identifier of the sub-stage. For example, a size of the reward identifier of the stage may be larger than a size of the reward identifier of the sub-stage, or the reward identifier of the stage and the reward identifier of the sub-stage may include different marks, or the reward identifier of the stage and the reward identifier of the sub-stage may be in different shapes, or the like.

In some embodiments, to display, between the reward identifier of the first target stage and the reward identifier of the second target stage, reward identifiers of sub-stages within the first target stage, a position of the reward identifier of the first target stage or a position of the reward identifier of the second target stage needs to be changed, to reserve sufficient display space for the sub-stages within the first target stage. To help a user browse the reward identifier of the first target stage and the reward identifier of the sub-stage within the first target stage together, the reward identifier of the second target stage may be moved, to be specific, the reward identifier of the second target stage is moved backward until a distance between the reward identifier of the first target stage and the reward identifier of the second target stage is sufficient for displaying the reward identifiers of the sub-stages within the first target stage. In some embodiments, in response to the reward identifier of the first target stage is selected again, display of the reward identifier of the sub-stage within the first target stages is canceled, and the reward identifier of the second target stage is moved forward until the reward identifier of the second target stage is located right behind the reward identifier of the first target stage.

In some embodiments, to improve vividness of a reward collection interface and improve a display effect of the reward collection interface, the displaying, between the reward identifier of the first target stage and the reward identifier of the second target stage, the reward identifier of the sub-stage within the first target stage in response to the reward identifier of the first target stage being selected may include: displaying a reward display animation in response to the reward identifier of the first target stage being selected, the reward display animation being an animation in which the reward identifier of the second target stage moves away from the reward identifier of the first target stage, and the reward identifier of the sub-stage within the first target stage appears. For example, the reward display animation may be an animation in which the reward identifier of the second target stage gradually moves away from the reward identifier of the first target stage, and each time a distance between the reward identifier of the second target stage and the reward identifier of the first target stage is sufficient for displaying a reward identifier of a sub-stage, a reward identifier of a sub-stage within the first target stage is displayed, until the reward identifiers of the sub-stages within the first target stage is displayed. In this case, a reward disappearance animation is displayed in response to the reward identifier of the first target stage being selected again. The reward disappearance animation may be an animation in which the reward identifier of the sub-stage within the first target stage disappears and the reward identifier of the second target stage approaches the reward identifier of the first target stage. For example, the reward disappearance animation may be an animation in which the reward identifiers of the sub-stages within the first target stage disappear one by one, and as the reward identifiers of the sub-stages disappear, the reward identifier of the second target stage gradually moves forward, gradually moves closer to the reward identifier of the first target stage, and stops moving until the reward identifier of the second target stage is located right behind the reward identifier of the first target stage.

In a second embodiment, a plurality of stages in the event are arranged in sequence, and reward identifiers of the stages in the event are also sequentially arranged in a sequence of the plurality of stages, and are displayed in a first direction. The first direction is a horizontal direction, a vertical direction, another direction, or the like. In this case, when reward identifiers of the stages on the event reward interface are displayed in the first direction, operation 202 includes: displaying the reward identifier of the sub-stage within the first target stage in a second direction in response to the reward identifier of the first target stage being selected. The first direction and the second direction are perpendicular to each other. Accordingly, the reward identifier of the sub-stage within the first target stage and reward identifiers of different stages can be respectively displayed in different directions, to ensure that the reward identifier of the sub-stage within the first target stage does not affect normal display of a reward identifier of a stage.

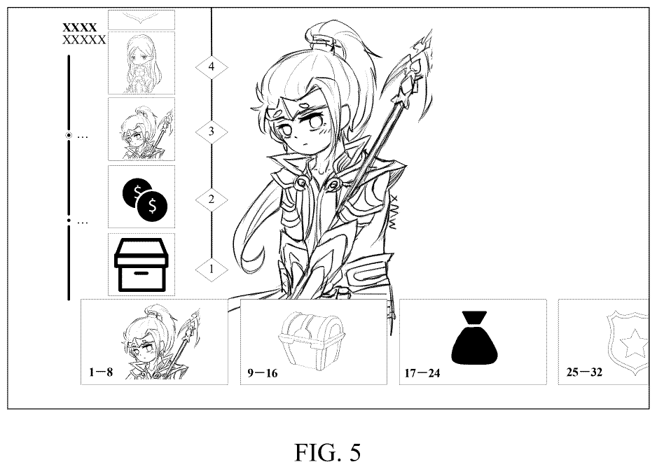

As shown in FIG. 3, on the event reward interface, a plurality of reward icons of level intervals are displayed horizontally. As shown in FIG. 5, when a reward icon of the 1^{st} level interval is selected, reward icons of levels within the 1^{st} level interval is displayed vertically above the reward icon of the 1^{st} level interval. When the reward icon of the 1^{st} level interval is selected again, the reward icons of the levels within the 1^{st} level interval are folded, and the event reward interface is restored to a style shown in FIG. 3.

In a third embodiment, the event reward interface includes a reward identifier region, and the reward identifier region is configured for displaying a reward identifier of the event. For example, as shown in FIG. 3, a reward identifier region 301 is located at the bottom of the event reward interface. In this case, operation 202 includes: displaying, in the reward identifier region, the reward identifier of the sub-stage within the first target stage in response to the reward identifier of the first target stage being selected.

When a size of the reward identifier region is unchangeable, displaying, in the reward identifier region, the reward identifier of the sub-stage within the first target stage occupies some display space. In this case, display of reward identifiers of one or more stages is canceled, to reserve more display space. Alternatively, when a size of the reward identifier region is changeable, the reward identifier of the sub-stage within the first target stage are displayed in the reward identifier region while preserving reward identifiers of previously displayed stages.

In some embodiments, the event reward interface includes a display control, and the display control is configured for displaying the reward identifier of the event. The display control may be disposed in the reward identifier region, or may be disposed in another region of the event reward interface. In addition, the display control supports a sliding operation and a page turning operation. In this case, the method further includes at least one of the following.

1. Display, in the display control, a reward identifier corresponding to the slide operation in response to the sliding operation on the display control.

Reward identifiers, including a reward identifier of a stage, a reward identifier of a sub-stage, and the like, are displayed in the display control. Because a size of the display control is limited, not all reward identifiers can be displayed. However, when a user performs a sliding operation on the display control, the terminal may display, based on a sliding direction of the sliding operation in response to the sliding operation, another reward identifier located in the sliding direction. The sliding operation may include an upward sliding operation, a downward sliding operation, a leftward sliding operation, a rightward sliding operation, or the like.

2. Display, in the display control, a reward identifier corresponding to the page turning operation in response to the page turning operation on the display control.

Reward identifiers, including a reward identifier of a stage, a reward identifier of a sub-stage, and the like, are displayed in the display control. Because a size of the display control is limited, not all reward identifiers can be displayed. Instead, all the reward identifiers are divided into a plurality of pages, and a reward identifier of only one page is displayed each time. If a user performs a page turning operation on the display control, the terminal can display, in response to the page turning operation, a page corresponding to the page turning operation. For example, the display control includes a page up button and a page down button. In this case, in response to a trigger operation on the page up button, a previous page of a current page is displayed in the display control, and in response to a trigger operation on the page down button, a page following the current page is displayed in the display control.

The third embodiment may be combined with the first embodiment or the second embodiment, to form a new embodiment. This is not limited in one embodiment.

Based on the embodiment shown in FIG. 2, an embodiment of this application further provides another method for displaying an interface. FIG. 6 is a flowchart of another method for displaying an interface according to one embodiment. One embodiment is performed by a terminal. Refer to FIG. 6. The method includes the following operations.

601: Display, on an event reward interface, a core reward identifier of at least one stage in an event, and perform operations 602 and 603.

The core reward identifier is configured for representing a core reward for a stage, and the core reward is a reward that is in rewards for sub-stages within the stage and that meets a core condition. The core condition may be set by a technical person or set by a user.

For example, if the core condition is: being marked as a core, the core reward for the stage is a reward marked as a core in rewards for sub-stages within the stage. Alternatively, if the core condition is: a reward for the 1^{st} sub-stage or a reward for the last sub-stage, the core reward for the stage is the reward for the 1^{st} sub-stage or the reward for the last sub-stage within the stage. Alternatively, if the core condition is: a reward having the highest popularity, the core reward for the stage is a reward currently having the highest popularity in rewards for sub-stages within the stage.

In addition, there may be one core reward for one stage. In this case, when rewards for a plurality of sub-stages all meet the core condition, one reward may be randomly selected, as the core reward, from all the rewards that meet the core condition. Alternatively, there may be a plurality of core reward for one stage. In this case, the core reward identifier displayed may include information about the plurality of core rewards. For example, the core reward identifier may be a core reward icon, the core reward icon may include pictures of all core rewards, and a user can learn about all the core rewards for the stage by viewing the core reward icon.

A specific process of operation 601 is similar to the process of the foregoing operation 201. Details are not described herein again.

602: Display detailed information about a core reward for a first target stage in response to a core reward identifier of the first target stage being selected.

The detailed information about the core reward is configured for introducing the core reward. The detailed information about the core reward may include a plurality of types of information about the core reward, for example, a name, a picture, and a text description of the core reward. For example, when the core reward is a virtual character, the detailed information about the core reward may include a model of the virtual character, or when the core reward is a virtual item, the detailed information about the core reward may include an icon of the virtual item. An amount of the detailed information about the core reward may be more than an amount of information provided by the core reward identifier, so that if a user browses the core reward identifier and is interested in the core reward, the user may select the core reward identifier, to further obtain more information about the core reward.

In some embodiments, the event reward interface may include a reward identifier region and a reward information region. The reward identifiers of the event are displayed in the reward identifier region, and detailed information about a reward corresponding to a reward identifier selected in the reward identifier region is displayed in the reward information region. For example, as shown in FIG. 3, the reward identifier region 301 is located at an upper layer of a reward information region 302, and covers a part of the reward information region 302. Detailed information about a core reward for the level interval “1-8” is displayed in the reward information region 302 in response to a core reward identifier of the level interval “1-8” being selected.

603: Display a reward identifier of a sub-stage within the first target stage in response to the core reward identifier of the first target stage being selected.

The first target stage is any stage in the event, and the reward identifier of the sub-stage is configured for representing a reward allowed to be collected after the sub-stage is completed.

A specific process of operation 603 is similar to the process of the foregoing operation 202. Details are not described herein again.

604: The terminal displays detailed information about a reward for a first target sub-stage in response to a reward identifier of the first target sub-stage being selected.

The first target sub-stage is any sub-stage within the first target stage.

The detail information about the reward for the first target sub-stage is configured for introducing the reward for the first target sub-stage, and includes a plurality of types of information about the reward, for example, a name, a picture, and a text description of the reward. For example, the reward is a virtual character, and the detailed information about the reward may include a model of the virtual character. Alternatively, the reward is a virtual item, and the detailed information about the reward may include an icon of the virtual item. In addition, an amount of the detailed information about the reward is more than an amount of information about the reward in the reward identifier of the first target sub-stage. If a user browses the reward identifier and is interested in the reward, the user may select the reward identifier, to browse more information about the reward.

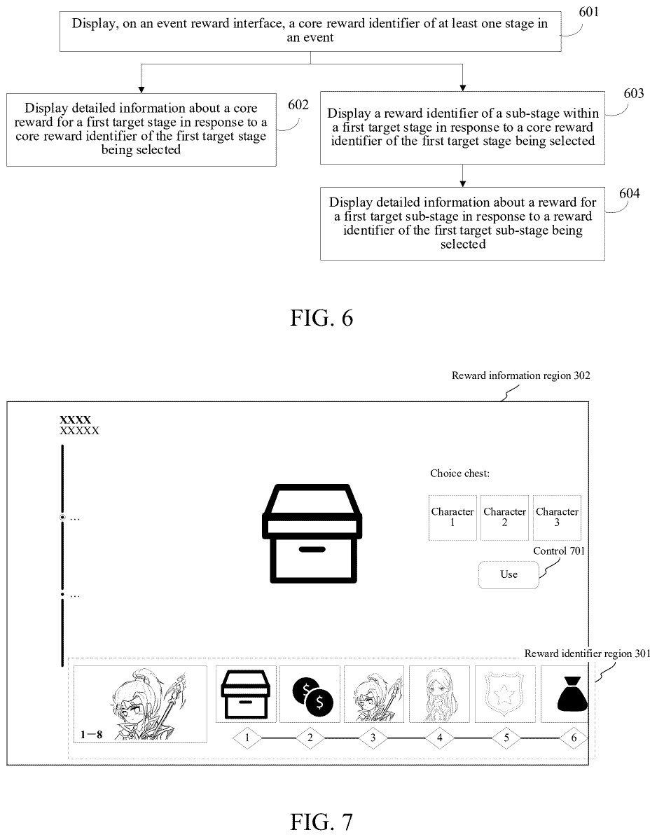

In some embodiments, the event reward interface may include a reward identifier region and a reward information region. The reward identifiers of the event are displayed in the reward identifier region, and detailed information about a reward corresponding to a reward identifier selected in the reward identifier region is displayed in the reward information region. For example, as shown in FIG. 7, in response to a reward identifier of the 1^{st} sub-stage (that is, a level 1) in a reward identifier region 301 being selected, detailed information corresponding to the reward identifier is displayed in a reward information region 302, and optional characters (for example, a character 1, a character 2, and a character 3) in a reward “choice chest” for the level 1 are described in detail.

If the terminal has completed the first target sub-stage, the terminal may collect the reward for the first target sub-stage. In some embodiments, when displaying the reward identifier of the first target sub-stage, the terminal further displays a reward collection control corresponding to the reward identifier. In response to a trigger operation on the reward collection control, the terminal collects a reward corresponding to the reward collection control, in other words, collects the reward for the first target sub-stage. For example, the reward for the first target sub-stage is stored into an item inventory of a terminal account.

In addition, the terminal may further display a separate reward collection control on the event reward interface. The reward collection control is configured for collecting all rewards that can be collected with one tap/click. In this case, the terminal may collect, in response to a trigger operation on the reward collection control, a reward corresponding to the reward collection control, in other words, all rewards that can be collected by the terminal. All the rewards that can be collected by the terminal may include only a reward for each sub-stage that is completed by the terminal, or may include both a reward for each sub-stage that is completed by the terminal and an additional reward.

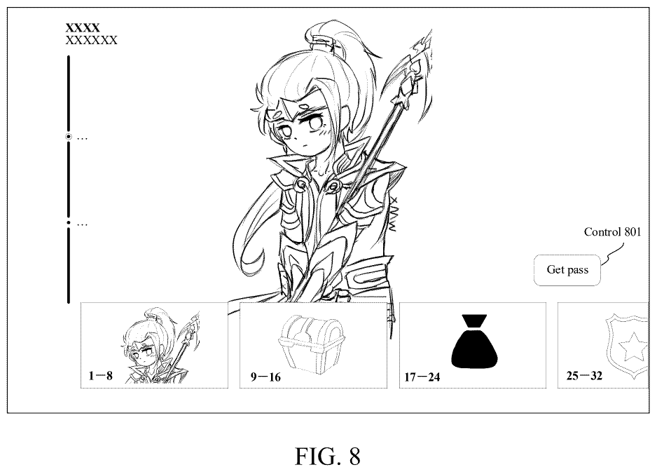

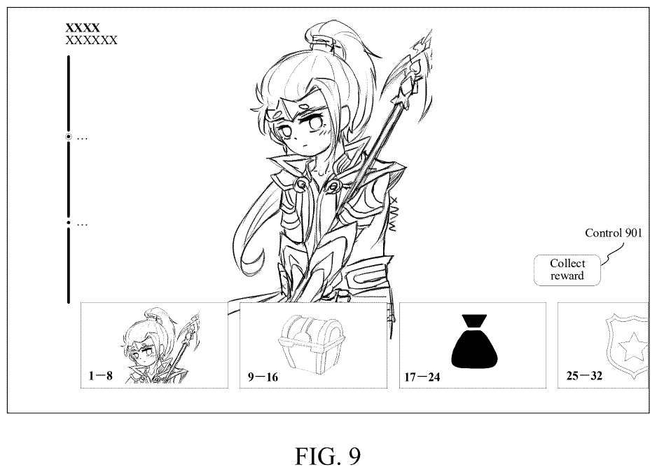

As shown in FIG. 8, a get pass control 801 is displayed based on the event reward interface. Before or after browsing a reward identifier, a user can trigger the get pass control 801 to obtain a pass of an event, toto obtain participation permission of the event. Then, when obtaining the pass of the event, the terminal may participate in the event. In addition, as shown in FIG. 9, a reward collection control 901 may further be displayed on the event reward interface, and all rewards that can be collected by the terminal may be collected with one tap/click by triggering the reward collection control 901.

In some embodiments, to help the terminal use a reward, when the reward for the first target sub-stage is collected, a use control is displayed, and then the terminal may use the reward for the first target sub-stage in response to a trigger operation on the use control. Accordingly, a path for displaying the use control is shortened, to shorten an operation process of using the reward, toto improve operation efficiency. For example, the reward for the first target sub-stage is a special-effect avatar. After a user has collected the avatar, the terminal may display the use control on the event reward interface, and when the user triggers the use control, the terminal replaces a current avatar of the user with the rewarded avatar. The use control may be displayed at any position on the event reward interface. For example, when displaying reward detailed information in the reward information region, the terminal further displays the use control in the reward information region. Alternatively, the terminal displays the use control in a region that is in the reward identifier region and that is adjacent to the reward identifier of the first target sub-stage.

For example, as shown in FIG. 7, reward detailed information and a use control 701 are displayed in a reward information region on the event reward interface. A user can use a character selected from a choice chest by triggering the use control 701.

In one embodiment, a reward identifier of at least one stage in the event is displayed based on the event reward interface, and when the reward identifier of the first target stage is selected, the reward identifier of the sub-stage within the first target stage is then displayed, rather than displaying all the reward identifiers at once. Accordingly, a quantity of reward identifiers displayed once can be effectively reduced, so that a stage-level relationship between different reward identifiers may be intuitively presented, and it is easier for a user to browse reward identifiers of the event. Furthermore, efficiency of reward viewing is improved, display region required for reward display can be minimized, and an impact on use of another function in an application is reduced.

In addition, a core reward identifier of at least one stage is first displayed based on the event reward interface, and a core reward for the stage is described by using the core reward identifier. When there is no interference from a reward identifier of a sub-stage, it is convenient for a user to quickly learn about a core reward for each stage in the event, so that a complex browsing operation such as a sliding operation or a page turning operation is reduced, and browsing efficiency of the reward identifiers is improved.

In addition, detailed information about a reward corresponding to a reward identifier is displayed by selecting the reward identifier, to introduce a reward that can be collected by the terminal in detail, toto improve an amount of displayed information. In addition, an operation path from previewing a reward to collecting the reward and then using the reward is shortened by displaying the reward detailed information, the reward collection control, and the use control, to improve operation efficiency, toto more easily improve user viscosity, and attract more users to participate in the event.

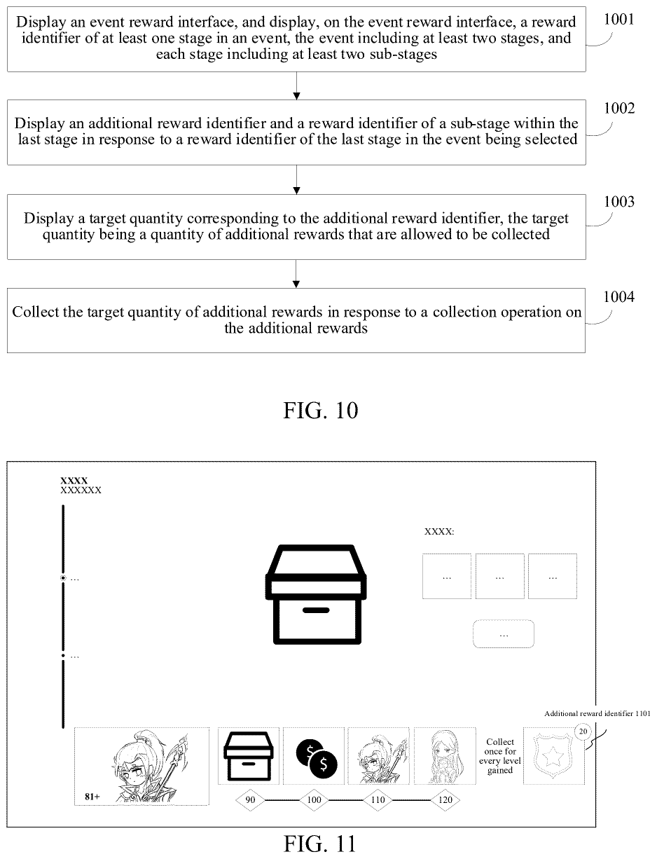

In one embodiment, the first target stage may further include the last stage in the at least two stages included in the event. In this case, an embodiment of this application further provides another method for displaying an interface. FIG. 10 is a flowchart of another method for displaying an interface according to one embodiment. One embodiment is performed by a terminal. Refer to FIG. 10. The method includes the following operations.

1001: Display an event reward interface, and display, on the event reward interface, a reward identifier of at least one stage in an event, the event including at least two stages, and each stage including at least two sub-stages.

A process of operation 1001 is similar to the process of the foregoing operation 201. Details are not described herein again.

1002: Display an additional reward identifier and a reward identifier of a sub-stage within the last stage in response to a reward identifier of the last stage in the event being selected.

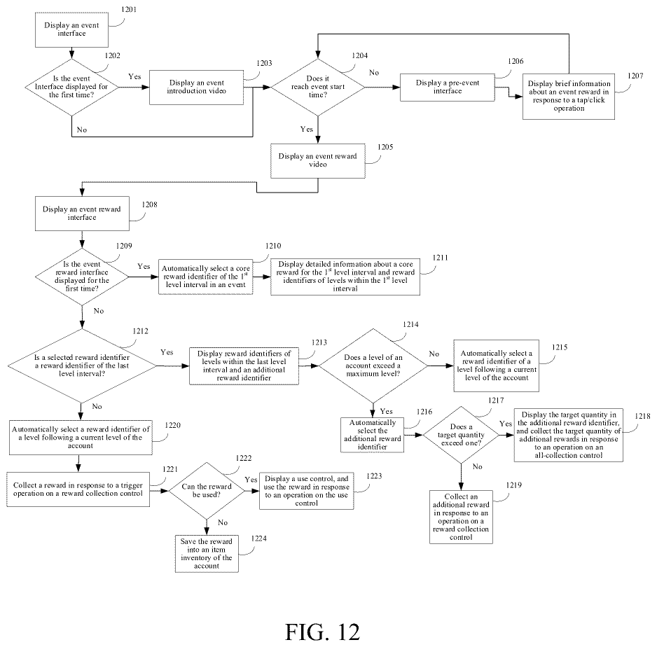

Considering that the terminal may continue to participate in the event after completing the last sub-stage of the event, to improve engagement of a user, an additional reward is further provided. The additional reward is a reward allowed to be collected by the terminal after the last stage in the event is completed, and an additional reward identifier is configured for representing the additional reward allowed to be collected after the last stage in the event is completed. When the reward identifier of the last stage in the event is selected, the reward identifier of the sub-stage within the last stage needs to be displayed, and the additional reward identifier may be also displayed. As shown in FIG. 11, four levels: 90, 100, 110, and 120 are set in a level interval “81+”. When a reward identifier of the level interval “81+” is selected, reward identifiers of the foregoing four levels are displayed, and an additional reward identifier 1101 is also displayed.

In addition, when the additional reward identifier is selected, the terminal may display detailed information about an additional reward on the event reward interface. A display manner is similar to the display manner of the detailed information in the foregoing embodiment. Details are not described herein again.

1003: Display a target quantity corresponding to the additional reward identifier, the target quantity being a quantity of additional rewards that are allowed to be collected.

The target quantity matches an event completion status of a logged-in account. As the event progresses, the event completion status of the account changes, so that the target quantity also changes. For example, the target quantity is increased by 1 for every level the account gains, or the target quantity is increased by 1 for every 10 levels the account gains.

As shown in FIG. 11, a target quantity “20” is displayed at an upper right corner of the additional reward identifier 1101, to represent that the terminal may currently collect 20 additional rewards.

1004: Collect the target quantity of additional rewards in response to a collection operation on the additional rewards.

The collection operation on the additional rewards may be an operation of selecting an additional reward identifier, or may be a trigger operation on a reward collection control. The reward collection control is configured for collecting all rewards that can be collected by the terminal with one tap/click, and all the rewards that can be collected by the terminal also include the additional reward.

Operations 1003 and 1004 are optional operations, and operations 1003 and 1004 may not be performed in another embodiment. For example, the additional reward is allowed to be collected only once, and the terminal no longer displays the target quantity. When the terminal meets a collection condition of the additional reward, the additional reward can be collected in response to the collection operation on the additional rewards.

One embodiment provides a special display style for the last stage. When a reward identifier of the last stage is selected, the reward identifier of the sub-stage within the last stage may be displayed, and the additional reward identifier may also be displayed, so that a user learns about the additional reward and collects the additional reward, to avoid a situation in which the terminal stops participating in the event after the last stage of the event is completed, toto improve engagement of the user to participate in the event.

In addition, the target quantity of additional rewards that are allowed to be collected matches the event completion status of the logged-in account on the terminal, and changes as the event completion status changes, so that the user can be encouraged to participate more in the event, to increase the target quantity and collect a larger quantity of additional rewards.

Based on the foregoing embodiment, in one embodiment, an example in which a stage is a level interval of an account, and a sub-stage is a level of the account is used to further describe an operation process of a terminal. Refer to FIG. 12. The operation process further includes the following operations.

Operation 1201: Display an event interface.

Operation 1202: Determine whether the event interface is displayed for the first time, and perform operation 1203 if the event interface is displayed for the first time; or perform operation 1204 if the event interface is not displayed for the first time.

Operation 1203: Display an event introduction video (for example, a world view video).

Operation 1204: Determine whether event start time is reached, and perform operation 1205 if the event start time is reached; or perform operation 1206 if the event start time is not reached.

Operation 1205: Display an event reward video.

Herein, a reward that can be obtained by participating in the event is described by using the event reward video.

Operation 1206: Display a pre-event interface.

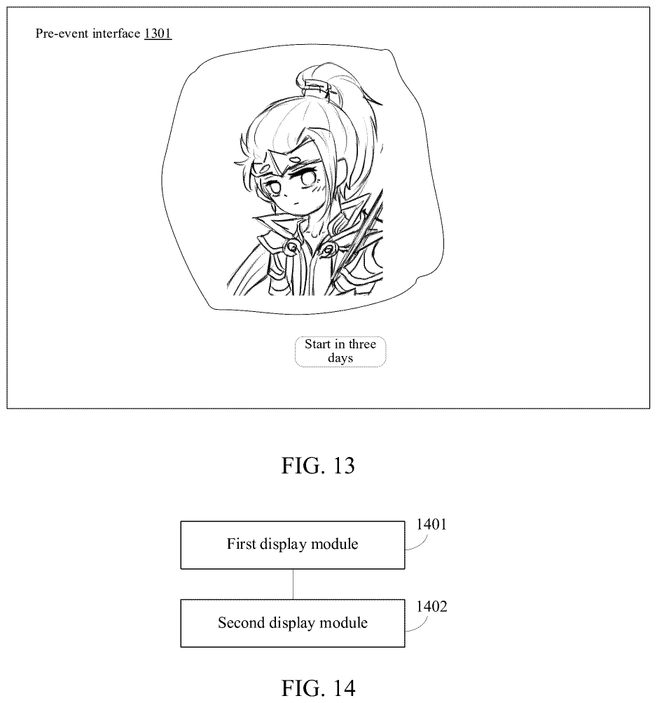

The pre-event interface is shown in FIG. 13. A silhouette picture of a reward and information about time remaining before the start of an event, for example, “Start in three days”, are displayed in a partial region of the pre-event interface 1301.

Operation 1207: Display brief information about an event reward in response to a tap/click operation.

Herein, the brief information about the event reward, for example, a silhouette picture of the reward, may be displayed in response to an operation of tapping/clicking the pre-event interface, and then the terminal stays on the pre-event interface until the event start time is reached.

Operation 1208: Display an event reward interface.

In this case, the terminal may display information, such as a theme of the current event, on the pre-event interface.

Operation 1209: Determine whether the event reward interface is displayed for the first time, and perform operation 1210 if the event reward interface is displayed for the first time; or perform operation 1212 if the event reward interface is not displayed for the first time.

Operation 1210: Automatically select a core reward identifier of the 1^{st} level interval in the event. Then, operation 1211 is performed.

Operation 1211: Display detailed information about a core reward for the 1^{st} level interval and reward identifiers of levels within the 1^{st} level interval.

Operation 1212: Determine whether a selected reward identifier is a reward identifier of the last level interval, and perform operation 1213 if the selected reward identifier is the reward identifier of the last level interval; or perform operation 1220 if the selected reward identifier is not the reward identifier of the last level interval.

Operation 1213: Display reward identifiers of levels within the last level interval and an additional reward identifier. Then, operation 1214 is performed.

Operation 1214: Determine whether a level of an account exceeds a maximum level, and perform operation 1216 if the level of the account exceeds the maximum level; or perform operation 1215 if the level of the account does not exceed the maximum level.

Operation 1215: Automatically select a reward identifier of a level following a current level of the account.

Operation 1216: Automatically select the additional reward identifier.

Operation 1217: Determine whether a target quantity exceeds one, and perform operation 1218 if the target quantity exceeds one; or perform operation 1219 if the target quantity does not exceed one.

Operation 1218: Display the target quantity in the additional reward identifier, and collect the target quantity of additional rewards in response to an operation on an all-collection control.

Operation 1219: Collect an additional reward in response to an operation on a reward collection control.

Operation 1220: Automatically select a reward identifier of a level following a current level of the account.

Operation 1221: Collect a reward in response to a trigger operation on the reward collection control.

Operation 1222: Determine whether the reward can be used, and perform operation 1223 if the reward can be used; or perform operation 1224 if the reward cannot be used.

Operation 1223: Display a use control, and use the reward in response to an operation on the use control.

Operation 1224: Save the reward into an item inventory of the account.

So far, this concludes a description of the method for displaying an interface provided in one embodiment by using an example in which the electronic device is the terminal.

An embodiment of this application provides an interface display apparatus. FIG. 14 is a schematic diagram of a structure of the interface display apparatus according to one embodiment. Refer to FIG. 14. The apparatus includes:
a first display module 1401, configured to display an event reward interface, and display, on the event reward interface, a reward identifier of at least one stage in an event, the event including at least two stages, and each stage including at least two sub-stages; and
a second display module 1402, configured to: display the reward identifier of the sub-stage within a first target stage in response to the reward identifier of the first target stage being selected, the first target stage being any one of the at least two stages included in the event.

A reward identifier of a sub-stage is configured for representing a reward allowed to be collected after the sub-stage is completed.

In a solution of one embodiment, a reward identifier of at least one stage in the event is displayed based on the event reward interface, and when the reward identifier of the first target stage is selected, the reward identifier of the sub-stage within the first target stage is then displayed, rather than displaying all the reward identifiers at once. Accordingly, a quantity of reward identifiers displayed once can be effectively reduced, so that it is easier for a user to browse reward identifiers of the event, to improve clarity and organization of the event reward interface. In addition, a stage-level relationship between different reward identifiers can be presented in a more clearly and organized manner, to improve a display effect of the event reward interface.

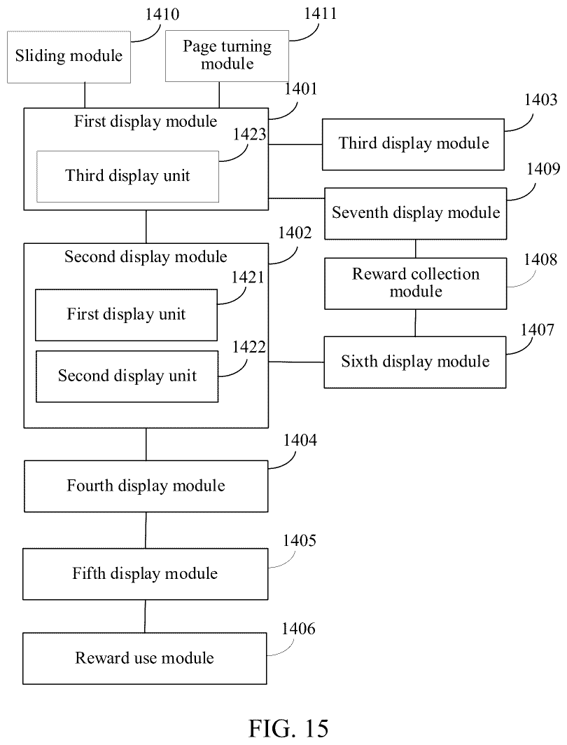

In the foregoing solution, at least one of the stages includes: the first target stage and a second target stage, and the second target stage is a next stage of the first target stage in the at least two stages included in the event. In this case, refer to FIG. 15. The second display module 1402 includes:
a first display unit 1421, configured to display, between the reward identifier of the first target stage and a reward identifier of the second target stage, the reward identifier of the sub-stage within the first target stage in response to the reward identifier of the first target stage being selected.

In the foregoing solution, the first display unit 1421 is further configured to display a reward identifier display animation in response to the reward identifier in the first target stage being selected, the reward identifier display animation being an animation in which the reward identifier of the second target stage moves away from the reward identifier of the first target stage, and the reward identifier of the sub-stage within the first target stage appears.

In the foregoing solution, refer to FIG. 15. A reward identifier of each stage is displayed on the event reward interface along a first direction, and the second display module 1402 includes:
a second display unit 1422, configured to display, along a second direction, the reward identifier of the sub-stage within the first target stage in response to the reward identifier of the first target stage being selected. The first direction and the second direction are perpendicular to each other.

In the foregoing solution, the second display module 1402 is further configured to cancel display of the reward identifier of the sub-stage within the first target stage in response to the reward identifier of the first target stage being selected again.

In the foregoing solution, refer to FIG. 15. The first display module 1401 includes:
a third display unit 1423, configured to display, on the event reward interface, a core reward identifier of at least one stage in the event, the core reward identifier being configured for representing a core reward for a stage, and the core reward is a reward that is in rewards for sub-stages within the stage and that meets a core condition.

In the foregoing solution, refer to FIG. 15. The interface display apparatus further includes:
a third display module 1403, configured to display detailed information about the core reward for the first target stage in response to the core reward identifier of the first target stage being selected.

In the foregoing solution, refer to FIG. 15. The interface display apparatus further includes:
a fourth display module 1404, configured to display detailed information about a reward for a first target sub-stage in response to the reward identifier of the first target sub-stage being selected, the first target sub-stage is any sub-stage within the first target stage.

In the foregoing solution, refer to FIG. 15. The interface display apparatus further includes:
a fifth display module 1405, configured to display a use control when the reward for the first target sub-stage has been collected; and
a reward use module 1406, configured to use the reward for the first target sub-stage in response to the use control being triggered.

In the foregoing solution, when the event reward interface is displayed for the first time, the first target stage includes the 1^{st} stage in the at least two stages included in the event. In this case, the second display module 1402 is further configured to display a reward identifier of a sub-stage within the 1^{st} stage in response to a reward identifier of the 1^{st} stage being selected.

In the foregoing solution, the first target stage includes the 1^{st} uncompleted stage. In this case, the second display module 1402 is further configured to display a reward identifier of a sub-stage within the 1^{st} uncompleted stage of an account in response to a reward identifier of the 1^{st} uncompleted stage of the account being selected.

In the foregoing solution, the first target stage includes the last stage in the at least two stages included in the event. The second display module 1402 is further configured to display an additional reward identifier and a reward identifier of a sub-stage within the last stage in response to a reward identifier of the last stage being selected, the additional reward identifier being configured for representing an additional reward allowed to be collected after the last stage of the event is completed.

In the foregoing solution, refer to FIG. 15. The interface display apparatus further includes:
a sixth display module 1407, configured to display a target quantity corresponding to the additional reward identifier, the target quantity being a quantity of additional rewards that are allowed to be collected, and the target quantity matching an event completion status of a logged-in account; and
a reward collection module 1408, configured to collect a target quantity of additional rewards in response to a collection operation on the additional rewards.

In the foregoing solution, refer to FIG. 15. The interface display apparatus further includes:
a seventh display module 1409, configured to display a reward collection control on the event reward interface; and
the reward collection module 1408, configured to collect a reward corresponding to the reward collection control in response to a trigger operation on the reward collection control.

In the foregoing solution, refer to FIG. 15. The event reward interface includes a display control, and the display control is configured for displaying reward identifiers of the event. The interface display apparatus further includes at least one of the following:
a sliding module 1410, configured to display, in the display control, a reward identifier corresponding to the sliding operation in response to the sliding operation in the display control; and
a page turning module 1411, configured to display, in the display control, a reward identifier corresponding to a page turning operation in response to the page turning operation in the display control.

The interface display apparatus provided in the foregoing embodiment is illustrated only with an example of division of the foregoing function modules. In practical applications, the foregoing functions may be allocated to and completed by different function modules based on requirements. That is, an internal structure of the electronic device is divided into different function modules to complete all or some of the functions described above. In addition, the interface display apparatus provided in the foregoing embodiment and the method for displaying an interface embodiments belong to the same conception. For details of the specific implementation process, refer to the method embodiments. Details are not described herein again.

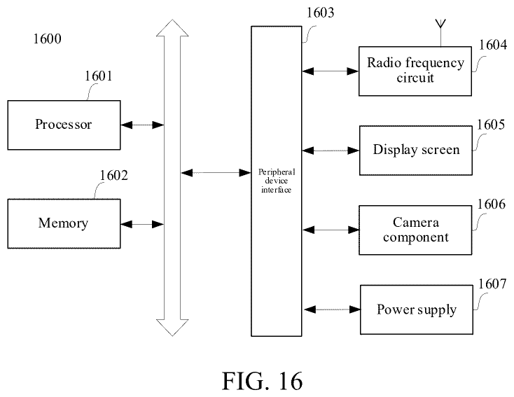

FIG. 16 is a schematic diagram of a structure of an electronic device 1600 according to an embodiment of this application.

The electronic device 1600 includes a processor 1601 and a memory 1602.

The processor 1601 may include one or more processing cores, for example, a 4-core processor or an 8-core processor. The processor 1601 may be implemented in at least one hardware form of digital signal processing (DSP), a field programmable gate array (FPGA), or a programmable logic array (PLA). The processor 1601 may alternatively include a main processor and a coprocessor. The main processor is a processor configured to process data in an awake state, and is also referred to as a central processing unit (CPU). The coprocessor is a low power consumption processor configured to process the data in a standby state. In some embodiments, the processor 1601 may be integrated with a graphics processing unit (GPU). The GPU is configured to render and draw content that needs to be displayed on a display screen. In some embodiments, the processor 1601 may further include an artificial intelligence (AI) processor. The AI processor is configured to process computing operations related to machine learning.

The memory 1602 may include one or more computer-readable storage media. The computer-readable storage media may be non-transient. The memory 1602 may also include a high-speed random access memory and a non-volatile memory, for example, one or more disk storage devices and flash storage devices. In some embodiments, the non-transitory computer-readable storage medium in the memory 1602 is configured to store at least one computer program or computer-executable instruction. The at least one computer program or the computer-executable instructions are configured to be executed by the processor 1601 to implement the method for displaying an interface provided in the method embodiment of this application.

In some embodiments, the electronic device 1600 may include a peripheral device interface 1603 and at least one peripheral device. The processor 1601, the memory 1602, and the peripheral device interface 1603 may be connected through a bus or a signal cable. Each peripheral device may be connected to the peripheral device interface 1603 through a bus, a signal cable, or a circuit board. In some embodiments, the peripheral device includes at least one of a radio frequency circuit 1604, a display screen 1605, a camera component 1606, and a power supply 1607.

The peripheral device interface 1603 may be configured to connect at least one peripheral device related to input/output (I/O) to the processor 1601 and the memory 1602. In some embodiments, the processor 1601, the memory 1602, and the peripheral device interface 1603 are integrated on a same chip or circuit board. In some other embodiments, any one or two of the processors 1601, the memory 1602, and the peripheral device interface 1603 may be implemented on a single chip or circuit board, which is not limited in this embodiment.

The radio frequency circuit 1604 is configured to receive and transmit a radio frequency (RF) signal, which is also referred to as an electromagnetic signal. The radio frequency circuit 1604 communicates with a communication network and another communication device through the electromagnetic signal. The radio frequency circuit 1604 converts an electric signal into an electromagnetic signal for transmission, or converts a received electromagnetic signal into an electric signal. In some embodiments, the radio frequency circuit 1604 includes an antenna system, an RF transceiver, one or more amplifiers, a tuner, an oscillator, a digital signal processor, a codec chip set, a subscriber identity module card, and the like. The radio frequency circuit 1604 may communicate with another device by using at least one wireless communication protocol. The wireless communication protocol includes, but is not limited to a metropolitan area network, generations of mobile communication networks (2G, 3G, 4G, and 5G), a wireless local area network, and/or a wireless fidelity (Wi-Fi) network. In some embodiments, the radio frequency circuit 1604 may further include a circuit related to near field communication (NFC), which is not limited in this application.

The display screen 1605 is configured to display a user interface (UI). The UI may include a graph, text, an icon, a video, and any combination thereof. When the display screen 1605 is a touch display screen, the display screen 1605 further has a capability of collecting a touch signal on or above a surface of the display screen 1605. The touch signal may be inputted to the processor 1601 as a control signal for processing. In this case, the display screen 1605 may be further configured to provide a virtual button and/or a virtual keyboard that are/is also referred to as a soft button and/or a soft keyboard. In some embodiments, there may be one display screen 1605 disposed on a front panel of the electronic device 1600. In some other embodiments, there may be at least two display screens 1605 respectively disposed on different surfaces of the electronic device 1600 or designed in a foldable shape. In some other embodiments, the display screen 1605 may be a flexible display screen disposed on a curved surface or a folded surface of the electronic device 1600. Even, the display screen 1605 may be further configured in a non-rectangular irregular pattern, namely, a special-shaped screen. The display screen 1605 may be prepared by using materials such as a liquid crystal display (LCD) or an organic light-emitting diode (OLED).

The camera component 1606 is configured to capture images or videos. In some embodiments, the camera component 1606 includes a front-facing camera and a rear-facing camera. The front-facing camera is disposed on a front panel of the electronic device 1600, and the rear-facing camera is disposed on a back surface of the electronic device 1600. In some embodiments, there are at least two rear-facing cameras, which are respectively any of a main camera, a depth-of-field camera, a wide-angle camera, and a telephoto camera, to achieve background blur through fusion of the main camera and the depth-of-field camera, panoramic photographing and virtual reality (VR) photographing through fusion of the main camera and the wide-angle camera, or other fusion photographing functions. In some embodiments, the camera component 1606 may further include a flash. The flash may be a monochrome temperature flash, or may be a double color temperature flash. The double color temperature flash is a combination of a warm light flash and a cold light flash, and may be used for light compensation under different color temperatures.

The power supply 1607 is configured to supply power to components in the electronic device 1600. The power supply 1607 may be an alternating current, a direct current, a disposable battery, or a rechargeable battery. When the power supply 1607 includes the rechargeable battery, the rechargeable battery supports wired charging or wireless charging. The rechargeable battery may further be configured to support a fast charge technology.

A person skilled in the art may understand that the structure shown in FIG. 16 does not constitute any limitation on the electronic device 1600, and the electronic device 1600 may include more or fewer components than those shown in the figure, or some components may be combined, or a different component deployment may be used.

An embodiment of this application further provides a computer-readable storage medium. The computer-readable storage medium has at least one computer program or computer-executable instructions stored thereon, and the at least one computer program or the computer-executable instructions are loaded and executed by a processor to implement operations performed in the method for displaying an interface in the foregoing embodiment.

An embodiment of this application further provides a computer program product, including a computer program or computer-executable instructions. The computer program or the computer-executable instructions are loaded and executed by a processor to implement operations performed in the method for displaying an interface provided in the foregoing embodiment.

A person of ordinary skill in the art may understand that all or some of steps of the foregoing embodiments may be implemented by hardware, or may be implemented by a program instructing relevant hardware. The program may be stored in a computer-readable storage medium. The storage medium may be a read-only memory, a magnetic disk, an optical disc, or the like.

The above descriptions are merely embodiments of embodiments of this application, and are not intended to limit embodiments of this application. Any modification, equivalent replacement, improvement, or the like made within the spirit and principle of the embodiments of this application falls within the protection scope of this application.

What is claimed is:

1. A method for displaying an interface, performed by an electronic device and comprising:
displaying an event reward interface, and displaying, a reward identifier of at least one stage in an event on the event reward interface, the event comprising at least two stages, and each stage comprising at least two sub-stages; and
displaying a reward identifier of a sub-stage within a first target stage in response to a reward identifier of the first target stage being selected, the first target stage being a stage in the at least two stages in the event, and
the reward identifier of the sub-stage representing a reward to be collected after the sub-stage is completed.

2. The method according to claim 1, wherein at least one of the stages comprises the first target stage and a second target stage, the second target stage being a next stage of the first target stage in the at least two stages comprised in the event; and
the displaying a reward identifier of a sub-stage within a first target stage in response to a reward identifier of the first target stage being selected comprises:
displaying, between the reward identifier of the first target stage and a reward identifier of the second target stage, the reward identifier of the sub-stage within the first target stage in response to the reward identifier of the first target stage being selected.

3. The method according to claim 2, wherein the displaying, between the reward identifier of the first target stage and a reward identifier of the second target stage, the reward identifier of the sub-stage within the first target stage in response to the reward identifier of the first target stage being selected comprises:
displaying a reward identifier display animation in response to the reward identifier of the first target stage being selected, the reward identifier display animation being an animation in which the reward identifier of the second target stage moves away from the reward identifier of the first target stage, and the reward identifier of the sub-stage within the first target stage appears.

4. The method according to claim 1, wherein a reward identifier of each stage on the event reward interface is displayed in a first direction; and the displaying a reward identifier of a sub-stage within a first target stage in response to a reward identifier of the first target stage being selected comprises:
displaying the reward identifier of the sub-stage within the first target stage in a second direction in response to the reward identifier of the first target stage being selected, the first direction and the second direction being perpendicular to each other.

5. The method according to claim 1, wherein the displaying a reward identifier of a sub-stage within a first target stage in response to a reward identifier of the first target stage being selected comprises:
displaying the reward identifier of the sub-stage within the first target stage in a reward identifier region in response to the reward identifier of the first target stage being selected.

6. The method according to claim 1, wherein after the displaying a reward identifier of a sub-stage within a first target stage in response to a reward identifier of the first target stage being selected, the method further comprises:
canceling display of the reward identifier of the sub-stage within the first target stage in response to the reward identifier of the first target stage being selected again.

7. The method according to claim 1, wherein the displaying, on the event reward interface, a reward identifier of at least one stage in an event comprises:
displaying a core reward identifier of at least one stage in the event on the event reward interface,
the core reward identifier representing a core reward for the stage, and the core reward being a reward that is in rewards for sub-stages within the stage and that meets a core condition.

8. The method according to claim 7, wherein after the displaying a core reward identifier of at least one stage in the event on the event reward interface, the method further comprises:
displaying detailed information about a core reward for the first target stage in response to a core reward identifier of the first target stage being selected.

9. The method according to claim 1, wherein after the displaying a reward identifier of a sub-stage within a first target stage in response to a reward identifier of the first target stage being selected, the method further comprises:
displaying detailed information about a reward for a first target sub-stage in response to a reward identifier of the first target sub-stage being selected,
the first target sub-stage being any one of sub-stages within the first target stage.

10. The method according to claim 9, after the displaying detailed information about a reward for a first target sub-stage in response to a reward identifier of the first target sub-stage being selected, the method further comprises:
displaying a use control when the reward for the first target sub-stage has been collected; and
using the reward for the first target sub-stage in response to the use control being triggered.

11. The method according to claim 1, wherein when the event reward interface is displayed for the first time, the first target stage comprises the 1^{st} stage in the at least two stages comprised in the event; and
the displaying a reward identifier of a sub-stage within a first target stage in response to a reward identifier of the first target stage being selected comprises:
displaying a reward identifier of a sub-stage within the 1^{st} stage in response to a reward identifier of the 1^{st} stage being selected.

12. The method according to claim 1, wherein the first target stage comprises the 1^{st} uncompleted stage; and the displaying a reward identifier of a sub-stage within a first target stage in response to a reward identifier of the first target stage being selected comprises:
displaying a reward identifier of a sub-stage within the 1^{st} uncompleted stage of an account in response to a reward identifier of the 1^{st} uncompleted stage of the account being selected.

13. The method according to claim 1, wherein the first target stage comprises the last stage in the at least two stages in the event; and the displaying a reward identifier of a sub-stage within a first target stage in response to a reward identifier of the first target stage being selected comprises:
displaying an additional reward identifier and a reward identifier of a sub-stage within the last stage in response to a reward identifier of the last stage being selected, the additional reward identifier representing an additional reward to be collected after the last stage of the event is completed.

14. The method according to claim 13, wherein after the displaying an additional reward identifier and a reward identifier of a sub-stage within the last stage in response to a reward identifier of the last stage being selected, the method further comprises:
displaying a target quantity corresponding to the additional reward identifier, the target quantity being a quantity of additional rewards that are to be collected, and the target quantity matching an event completion status of a logged-in account; and
collecting the target quantity of additional rewards in response to a collection operation on the additional rewards.

15. The method according to claim 1, wherein after the displaying an event reward interface, and displaying a reward identifier of at least one stage in an event on the event reward interface, the method further comprises:
displaying a reward collection control on the event reward interface; and
collecting a reward corresponding to the reward collection control in response to a trigger operation on the reward collection control.

16. The method according to claim 1, wherein the event reward interface comprises a display control, the display control being configured for displaying a reward identifier of the event, and the method further comprises:
displaying a reward identifier corresponding to a sliding operation in the display control in response to the sliding operation in the display control; and
displaying a reward identifier corresponding to a page turning operation in the display control in response to the page turning operation in the display control.

17. An electronic device, comprising a processor and a memory, the memory having at least one computer program or computer-executable instructions stored therein, and the at least one computer program or the computer-executable instructions being loaded and executed by the processor to implement operations performed in the method for displaying an interface comprising:
displaying an event reward interface, and displaying, a reward identifier of at least one stage in an event on the event reward interface, the event comprising at least two stages, and each stage comprising at least two sub-stages; and
displaying a reward identifier of a sub-stage within a first target stage in response to a reward identifier of the first target stage being selected, the first target stage being a stage in the at least two stages in the event, and
the reward identifier of the sub-stage representing a reward to be collected after the sub-stage is completed.

18. The electronic device according to claim 17, wherein at least one of the stages comprises the first target stage and a second target stage, the second target stage being a next stage of the first target stage in the at least two stages comprised in the event; and
the displaying a reward identifier of a sub-stage within a first target stage in response to a reward identifier of the first target stage being selected comprises:
displaying, between the reward identifier of the first target stage and a reward identifier of the second target stage, the reward identifier of the sub-stage within the first target stage in response to the reward identifier of the first target stage being selected.

19. The electronic device according to claim 18, wherein the displaying, between the reward identifier of the first target stage and a reward identifier of the second target stage, the reward identifier of the sub-stage within the first target stage in response to the reward identifier of the first target stage being selected comprises:
displaying a reward identifier display animation in response to the reward identifier of the first target stage being selected, the reward identifier display animation being an animation in which the reward identifier of the second target stage moves away from the reward identifier of the first target stage, and the reward identifier of the sub-stage within the first target stage appears.

20. A non-transitory computer-readable storage medium, having at least one computer program or computer-executable instructions stored thereon, and the at least one computer program or the computer-executable instructions being loaded and executed by a processor to implement operations performed in a method for displaying an interface comprising:
displaying an event reward interface, and displaying, a reward identifier of at least one stage in an event on the event reward interface, the event comprising at least two stages, and each stage comprising at least two sub-stages; and
displaying a reward identifier of a sub-stage within a first target stage in response to a reward identifier of the first target stage being selected, the first target stage being a stage in the at least two stages in the event, and the reward identifier of the sub-stage representing a reward to be collected after the sub-stage is completed.
